(19) United States
(12) Patent Application Publication
(10) Pub. No.: US 2012/0082927 A1
(43) Pub. Date: Apr. 5, 2012

(54) TWO-COMPONENT DEVELOPER AND IMAGE FORMING METHOD

(76) Inventors: Takanori Kamoto, Osaka (JP); Takayuki Yamanaka, Osaka (JP); Osamu Wada, Osaka (JP); Tadashi Iwamatsu, Osaka (JP)

(21) Appl. No.: 13/237,602

(22) Filed: Sep. 20, 2011

(30) Foreign Application Priority Data
Sep. 30, 2010 (JP) P2010-222927

(51) Int. Cl. G03G 9/00; G03G 9/107; G03G 15/08

(52) U.S. Cl. 430/105; 399/252; 430/111.32

(57) ABSTRACT

A two-component developer includes a toner and a resin-coated carrier. To the toner, a plurality of types of external additives each of which has a different average primary particle size are externally added, at least one type of the external additives having an average primary particle size of 0.1 μm or more. The resin-coated carrier includes a carrier core formed of ferrite having a volume average particle size of 25 μm or more and 90 μm or less, and a resin coating layer that is formed on the surface of the carrier core and contains a magnetic fine particle having a volume average particle size of 0.1 μm or more and 2 μm or less and a silicone resin, wherein 40 parts by weight or more and 100 parts by weight or less of the magnetic fine particle based on 100 parts by weight of the silicone resin are contained.

### CROSS-REFERENCE TO RELATED APPLICATION

This application claims priority to Japanese Patent Application No. 2010-222927, which was filed on Sep. 30, 2010, the contents of which are incorporated herein by reference in its entirety.

### BACKGROUND OF THE TECHNOLOGY

1. Field of the Technology

The present technology relates to a two-component developer and an image forming method.

2. Description of the Related Art

Office automation (abbreviated as “OA”) equipment has been remarkably developed in these days and in line with such development, there has been a wide spread of copiers, printers, facsimile machines, and the like machines which form images through electrophotography.

In an image forming apparatus by means of an electrophotographic method, an image is formed, for example, through a charging step, an exposure step, a developing step, a transfer step, a cleaning step, a charge removing step, and a fixing step. At the charging step, the surface of a photoreceptor that is rotationally driven is uniformly charged by a charging device, and at the exposure step, the charged surface of the photoreceptor is irradiated with laser light by an exposure device to form an electrostatic latent image on the surface of the photoreceptor. At the developing step, the electrostatic latent image on the surface of the photoreceptor is then developed by a developing device with use of a developer to form a toner image on the surface of the photoreceptor, and at the transfer step, the toner image on the surface of the photoreceptor is transferred onto a transfer material by a transfer device. Thereafter, at the fixing step, the toner image is heated by a fixing device and thereby fixed onto the transfer material. Further, a transfer-remained toner that remains on the surface of the photoreceptor after image formation operation is removed by a cleaning device to be collected by a predetermined collecting section at the cleaning step, and at the charge removing step, a residual charge on the surface of the photoreceptor after cleaning is removed by a charge removing device for preparation of next image formation.

In the image forming apparatus employing electrophotography, as a developer for developing an electrostatic latent image on the surface of a photoreceptor, a one-component developer containing only a toner and a two-component developer containing a toner and a carrier are used. The two-component developer has functions of stirring, conveying and charging of a toner by a carrier that are imparted thereto so that the toner does not need to combine the functions of the carrier and the functions are separated between the toner and the carrier, thus having improved controllability compared to that of the one-component developer only containing the toner independently, and having a feature of easily obtaining a high-definition image. Therefore, various researches have been conducted concerning a method of manufacturing a toner suitable for combination use of the carrier.

A carrier has two fundamental functions: the function of stably charging a toner to a desired charge level, and the function of conveying a toner to a photoreceptor. Furthermore, a carrier is stirred in a developer tank, and borne onto a magnet roller, on which the carrier forms a magnetic brush. Subsequently, the carrier passes through a regulating blade, and then returns to the inside of the developer tank. This allows the carrier to be reused. In continuing use of the carrier, the carrier is required to stably realize the fundamental functions, particularly the function of stably charge a toner.

In order to maintain such functions of the carrier, for example, a method has been proposed such that the surface of a carrier core is coated with a styrene-acrylic copolymer resin or a polyurethane resin having high surface tension, and a fluororesin having low surface tension to form a resin coating layer containing these resins on the surface of the carrier core. However, when the resin coating layer is formed by a resin having high surface tension, adhesiveness with the carrier core is favorable, but a toner is easily spent, which poses a problem. Additionally, forming the resin coating layer with the fluororesin having low surface tension is effective against toner spent, however, adhesiveness with the carrier core is deteriorated, and therefore, when a resin-coated carrier is stirred in a developer tank, the resin coating layer comes off so as not to achieve stabilization of charging, which poses a problem.

In order to solve such problems, Japanese Unexamined Patent Publication JP-A 1-284862 (1989) discloses a resin-coated carrier in which a carrier core is coated with a silicone resin, and additionally, in order to obtain desired chargeability, a silicone coupling agent having an amino group is contained in a resin coating layer.

Incidentally, full-colorization of an electrophotography has been advanced recently, and accordingly, various improvements of a toner have been conducted. As a part of such improvements, there is an improvement of an external additive that is externally added onto the surface of a toner. An external additive of a toner imparts flowability to a toner and has a function as a control auxiliary agent for a charge amount. Since full-colorization tends to enlarge a particle size of a toner, aiming to enhance transfer efficiency thereof, as the particle size of the external additive that is externally added onto the surface of a toner becomes larger, a contact opportunity between a toner and a carrier is inhibited so that it becomes difficult to stably charge a toner. Further, a color toner, compared to a monochrome toner, has high insulation properties due to materials thereof so that it is difficult to stabilize charging.

In the resin-coated carrier disclosed in JP-A 1-24862, when a particle size of an external additive is enlarged for improving transfer efficiency of a toner, it is not possible to sufficiently charge the toner.

As a resin-coated carrier for stably charging a toner, Japanese Unexamined Patent Publication JP-A 2007-121911 discloses a resin-coated carrier that has a nonmagnetic fine particle contained in a resin coating layer. According to the resin-coated carrier disclosed in JP-A 2007-121911, even when the resin coating layer is worn away due to stirring with a toner, the nonmagnetic fine particle serves as a spacer to keep the distance between the toner and a carrier core constant, therefore it is possible to suppress increasing of Van der Waals force between the toner and the carrier core, so that it is possible to prevent the toner from adhering to the resin-coated carrier to maintain a charge donating capability to the toner.

Further, Japanese Unexamined Patent Publication JP-A 2009-93135 discloses a resin-coated carrier having noble metal such as gold, platinum and palladium that are contained in a resin coating layer to form a catenulate structure with four or more of an average connection particle number with noble metal thereof. According to the resin-coated carrier disclosed in JP-A 2009-93135, the catenulate structure is formed in a resin coating layer, and a conductive path is provided, so that it is possible to improve the charge donating capability to a toner.

Additionally, Japanese Unexamined Patent Publication JP-A 10-333363 (1998) discloses a resin-coated carrier having a carbon fine particle of 1 to 20 μm or a fine particle that is subjected to conductive treatment such as coating to the carbon fine particle that are contained in a resin coating layer. According to the resin-coated carrier disclosed in JP-A 10-333363, it is possible to suppress adhering of a toner to the resin-coated carrier and make rising of charging faster.

Further, Japanese Unexamined Patent Publication JP-A 61-296363 (1986) discloses a resin-coated carrier having a fine metal oxide particle that is contained in a resin coating layer. According to the resin-coated carrier disclosed in JP-A 61-296363, it is possible to strip off a toner that physically adheres to a photoreceptor, and form a favorable image.

However, with the resin-coated carriers disclosed in JP-A 2007-121911, JP-A 2009-93135 and JP-A 10-333363, it is impossible to sufficiently maintain the charge donating capability to a toner over a long period of time, and impossible to stably charge the toner.

Moreover, in JP-A 61-296363, there is no description about a toner to which an external additive is externally added, and transfer efficiency is insufficient depending on a toner in combination with a resin-coated carrier.

### SUMMARY OF THE TECHNOLOGY

An object of the technology is to provide a two-component developer with favorable transfer efficiency that is capable of stably charging a toner over a long period of time, and an image forming method.

The technology provides a two-component developer comprising:

a toner to which a plurality of types of external additives each of which has a different average primary particle size are externally added, at least one of the plurality of types of external additives having an average primary particle size of 0.1 μm or more; and

a resin-coated carrier comprising a carrier core formed of ferrite having a volume average particle size of 25 μm or more and 90 μm or less, and a resin coating layer that is formed on a surface of the carrier core and contains magnetic fine particles having a volume average particle size of 0.1 μm or more and 2 μm or less and a silicone resin, in which 40 parts by weight or more and 100 parts by weight or less of the magnetic fine particles based on 100 parts by weight of the silicone resin are contained,

a mixing ratio of the resin-coated carrier and the toner indicated by a ratio of a total projected area of the toner relative to a total surface area of the resin-coated carrier being 30% or more and 70% or less.

A two-component developer comprises a toner and a resin-coated carrier. To the toner, a plurality of types of external additives each of which has a different average primary particle size are added, and at least one type of the plurality of types of external additives has an average primary particle size of 0.1 μm or more. The resin-coated carrier comprises a carrier core formed of ferrite, and a resin coating layer that is formed on the surface of the carrier core and contains a silicone resin and a magnetic fine particle.

In the two-component developer, a plurality of types of external additives having different average primary particle sizes are externally added to a toner, and at least one type of the plurality of types of external additives has an average primary particle size of 0.1 μm or more, so that it is possible to improve transfer efficiency. Additionally, in such a resin-coated carrier in combination with a toner to which a plurality of external additives are added, magnetic fine particles are contained in a resin coating layer, so that it is possible to stably charge the toner over a long period of time. Such a two-component developer is used to form an image, so that it is possible to reproduce a high-definition image, and stably form a high-quality image having favorable color reproducibility as well as high image density, and scarce image defects such as a fog.

Further, the carrier core has a volume average particle size of 25 μm or more and 90 μm or less. The volume average particle size of the carrier core is 25 μm or more and 90 μm or less, so that it is possible to stably convey a toner to an electrostatic latent image formed on a photoreceptor as well as form a high-definition image over a long period of time.

Further, the magnetic fine particle has a volume average particle size of 0.1 μm or more and 2 μm or less. The volume average particle size of the magnetic fine particles is 0.1 μm or more and 2 μm or less, so that it is possible to prevent the magnetic fine particle from being eccentrically located in a resin coating layer and between the resin-coated carriers when the resin coating layer is formed on the surface of the carrier core, as well as form a uniform resin coating layer since asperities are not formed on the surface of the resin coating layer with the magnetic fine particle. Accordingly, it is possible to further improve the charge donating capability to a toner of the resin-coated carrier, and to stably charge the toner over a long period of time.

Further, the resin coating layer contains 40 parts by weight or more and 100 parts by weight or less of the magnetic fine particles based on 100 parts by weight of the silicone resin. By containing 40 parts by weight or more and 100 parts by weight or less of the magnetic fine particles based on 100 parts by weight of the silicone resin, an effect by having the magnetic fine particles that are contained in the resin coating layer is sufficiently exerted, while it is possible to form a uniform resin coating layer.

Since a mixing ratio of a resin-coated carrier and a toner indicated by a ratio of a total projected area of the toner relative to a total surface area of the resin-coated carrier is 30% or more and 70% or less, chargeability of a toner is maintained in a sufficient favorable condition at the time of development, and it is possible to stably form a high-definition image in a long term even in a high-speed image forming apparatus.

Further, it is preferable that the resin coating layer further contains organic fine particles comprising an organic substance.

Further, a resin coating layer further contains organic fine particles comprising an organic substance. The organic fine particles are contained in the resin coating layer, so that it is possible to more stably control chargeability.

Further, it is preferable that the organic fine particles are formed of a resin that is selected from a benzoguanamine resin, a melamine resin and a resin having a triazine ring.

Since the organic fine particles are formed of a resin that is selected from a benzoguanamine resin, a melamine resin and a resin having a triazine ring, it is possible to further stably control chargeability of a toner.

Further, the technology provides an image forming method comprising the steps of:

forming a latent image on an image bearing member; and

developing the latent image formed on the image bearing member to form a toner image with use of the two-component developer mentioned above.

The image forming method includes the steps of forming a latent image on an image bearing member; and developing the latent image formed on the image bearing member to form a toner image with use of the two-component developer mentioned above, therefore having excellent image reproducibility including color reproducibility, and it is possible to stably form a high-definition image with high image density in a long term.

### DETAILED DESCRIPTION

Hereinafter, description will be given in detail for preferred embodiments.

1. Two-Component Developer

The two-component developer according to one embodiment comprises a toner and a resin-coated carrier.

(Toner)

A toner contains a toner base particle. As materials of the toner base particle, a binder resin and a colorant are essential components, and in addition thereto, a charge control agent, wax and the like are usable. Additionally, to the toner base particle, a plurality of types of external additives each of which has a different average primary particle size are externally added.

The binder resin is not particularly limited, and can use the conventional binder resins for a black toner or a color toner. Examples of the binder resin include polyester-based resins; styrene-based resins such as polystyrene and a styrene-acrylic acid ester copolymer resin; acrylic resins such as polymethyl methacrylate; polyolefin-based resins such as polyethylene; polyurethane; and epoxy resins. Resins obtained by mixing a wax with a raw material monomer mixture and conducting a polymerization reaction may be used. The binder resins may be used each alone, or two or more of them may be used in combination.

Examples of the aromatic alcohol ingredient required for obtaining the polyester resin include bisphenol A, polyoxyethylene-(2.2)-2,2-bis(4-hydroxyphenyl)propane, polyoxyethylene-(2.0)-2,2-bis(4-hydroxyphenyl)propane, polyoxypropylene-(2.0)-2,2-bis(4-hydroxyphenyl)propane, polyoxypropylene-(2.2)-polyoxyethylene-(2.0),-2,2-bis(4-hydroxyphenyl)propane, polyoxypropylene-W-2,2-bis(4-hydroxyphenyl)propane, polyoxypropylene-(2.2)-2,2-bis(4-hydroxyphenyl)propane, polyoxypropylene-(2.4)-2,2-bis(4-hydroxyphenyl)propane, polyoxypropylene-(3.3)-2,2-bis(4-hydroxyphenyl)propane, and derivatives thereof.

Further, examples of the polybasic acid ingredient in the polyester resin include dibasic acids such as succinic acid, adipic acid, sebacic acid, azelaic acid, dodecenyl succinic acid, n-dodecyl succinic acid, malonic acid, maleic acid, fumaric acid, citraconic acid, itaconic acid, glutaconic acid, cyclohexane dicarboxylic acid, ortho-phthalic acid, isophthalic acid, and terephthalic acid, tri- or higher basic acids such as trimellitic acid, trimethinic acid, and pyromellitic acid, as well as anhydrides and lower alkyl esters thereof. With a view point of heat resistant cohesion, terephthalic acid or lower alkyl esters thereof are preferred.

An acid value of a polyester resin is preferably 5 to 30 mgKOH/g. When the acid vale of the polyester resin is less than 5 mgKOH/g, charging characteristics of the resin are deteriorated, and it is also difficult to disperse the charge control agent in the polyester resin. Thereby, harmful effects are exerted on charging rise characteristics and charging stability in continuous use. When the acid vale of the polyester resin exceeds 30 mgKOH/g, the polyester resin has high hygroscopicity so that chargeability of a toner becomes unstable.

For the colorant, those customarily used in this relevant field may be used including, for example, a yellow toner colorant, a magenta toner colorant, a cyan toner colorant, a black toner colorant and the like.

As a yellow toner colorant, examples thereof include, in reference to the color index classification, an azo dye such as C. I. Pigment Yellow 1, C. I. Pigment Yellow 5, C.I. Pigment Yellow 12, C. I. Pigment Yellow 15 and C. I. Pigment Yellow 17, an inorganic pigment such as a yellow iron oxide or an ocher, a nitro dye such as C. I. Acid Yellow 1, an oil soluble dye such as C. I. Solvent Yellow 2, C. I. Solvent Yellow 6, C. I. Solvent Yellow 14, C. I. Solvent Yellow 15, C. I. Solvent Yellow 19 or C. I. Solvent Yellow 21.

As a magenta toner colorant, examples thereof include, in reference to the color index classification, C.I. Pigment Red 49, C. I. Pigment Red 57, C. I. Pigment Red 81, C. I. Pigment Red 122, C. I. Solvent Red 19, C. I. Solvent Red 49, C. I. Solvent Red 52, C. I. Basic Red 10 and C. I. Disperse Red 15.

As a cyan toner colorant, examples thereof include, in reference to the color index classification, C. I. Pigment Blue 15, C. I. Pigment Blue 16, C. I. Solvent Blue 55, C. I. Solvent Blue 70, C. I. Direct Blue 25 and C. I. Direct Blue 86.

As a black toner colorant, examples thereof include carbon blacks such as channel black, roller black, disk black, gas furnace black, oil furnace black, thermal black, and acetylene black. The carbon black may be selected properly from among various kinds of carbon blacks mentioned above according to a target design characteristic of toner.

In addition to these pigments, a bright red pigment, a green pigment and the like are also usable as a colorant. The colorants may be used each alone, or two or more of them may be used in combination. Further, two or more of the similar color series are usable, or one of or two or more of the different color series are also usable.

The colorant may be used in the form of a masterbatch. The masterbatch of the colorant can be produced in the same manner as a general masterbatch. For example, a melted synthetic resin and a colorant are kneaded so that the colorant is uniformly dispersed in the synthetic resin, then the resultant mixture thus melt-kneaded is granulated to produce a masterbatch. For the synthetic resin, the same kind as the binder resin of the toner, or a synthetic resin having excellent compatibility with the binder resin of the toner is used. At this time, a ratio of the synthetic resin and the colorant to be used is not particularly restricted, but preferably 30 to 100 parts by weight based on 100 parts by weight of the synthetic resin. Further, the masterbatch is granulated so as to have a particle size of about 2 to 3 mm.

The amount of a colorant to be used is not particularly restricted, but preferably 5 to 20 parts by weight based on 100 parts by weight of the binder resin. This amount does not refer to the amount of the masterbatch, but to the amount of the colorant itself included in the masterbatch. By using a colorant within such a range, it is possible to form a high-density and extremely high-quality image without damaging various physical properties of the toner.

The charge control agent can use charge control agents for controlling positive charge or for controlling negative charge, conventionally used in this field. Examples of the charge control agent for controlling positive charge include basic dyes, quaternary ammonium salts, quaternary phosphonium salts, aminopyrine, pyrimidine compounds, multinuclear polyamino compounds, aminosilane, nigrosine dyes and its derivative, triphenylmethane derivatives, guanidine salts and amidine salts.

Examples of the charge control agent for controlling negative charge include oil-soluble dyes such as oil black and spirone black; metal-containing azo compounds, azo complex dyes, naphthenic acid metal salts, metal complexes and metal salts of salicylic acid and its derivative (metal is chromium, zinc, zirconium and the like), boron compounds, fatty acid soaps, long-chain alkyl carboxylic acid salts, and resin acid soaps.

Among them, the boron compound is particularly preferred as being free of heavy metal. The charge control agents may be used each alone, or two or more of them may be used in combination, according to need. The amount of the charge control agent used is not particularly limited and can appropriately be selected from a wide range. The amount of the charge control agent used is preferably 0.5 to 3 parts by weight based on 100 parts by weight of the binder resin.

The wax can use the one commonly used in this field, and examples thereof include a petroleum wax such as a paraffin wax and a derivative thereof; a microcrystalline wax and a derivative thereof; a hydrocarbon synthetic wax such as a Fischer-Tropsch wax and a derivative thereof; a polyolefin wax and a derivative thereof; a low-molecular-weight polypropylene wax and a derivative thereof; a polyolefin polymer wax (a low-molecular-weight polyethylene wax and the like) and a derivative thereof; a botanical wax such as a carnauba wax and a derivative thereof; a rice wax and a derivative thereof; a candelilla wax and a derivative thereof; a plant wax such as a Japan wax; an animal wax such as a beeswax and a spermaceti wax; a synthetic wax of fat and oil such as a fatty acid amide and a phenol fatty acid ester; a long-chain carboxylic acid and a derivative thereof; a long-chain alcohol and a derivative thereof; a silicone polymer; and a higher fatty acid. Note that examples of the derivatives include an oxide, a vinyl monomer-wax block copolymer and a vinyl monomer-wax graft modified material. The amount of the wax to be used is not particularly limited and can appropriately be selected from a wide range. The amount of the wax to be used is preferably 0.2 to 20 parts by weight based on 100 parts by weight of the binder resin.

In toner preparation, these raw materials of the toner base particle are mixed by a mixer such as HENSCHEL MIXER, SUPERMIXER, MECHANOMILL or a Q-type mixer. The resultant mixture is melt-kneaded by a kneader such as a biaxial kneader, a uniaxial kneader or a continuous double-roll kneader, at a temperature of approximately 70 to 180° C., and the resultant melt-kneaded product is cooled and solidified.

The melt-kneaded product after being cooled and solidified is coarsely pulverized by a cutter mill, a feather mill or the like, and thereafter the coarsely pulverized materials are finely pulverized. For fine pulverization, a jet mill, a fluidized-bed jet grinder or the like is used. These pulverizers perform pulverization of the coarsely pulverized materials by causing air currents which include the coarsely pulverized materials to collide with one another in a plurality of directions, thereby causing the coarsely pulverized materials to collide with one another. Such a pulverizer is commercially available from Hosokawa Micron Corporation, or the like. Thereby, a toner base particle is obtained. Further, particle size adjustment such as classification may be performed as necessary.

In the embodiment, to a toner base particle, a plurality of types of external additives each of which has a different average primary particle size are externally added, and at least one type of the plurality of types of external additives has a 0.1 μm or more average primary particle size. A plurality of types of external additives having different average primary particle sizes are externally added, and at least one type of those external additives has an average primary particle size of 0.1 μm or more, so that it is possible to improve transfer efficiency. Moreover, the average primary particle size of the plurality of types of external additives is preferably 0.2 μm or less.

As a plurality of types of external additives having different average primary particle sizes, for example, when two types of external additives having different average primary particle sizes are used the average primary particle size of the external additive having a smaller average primary particle size is preferably 0.007 μm or more and 0.05 μm or less, and the average primary particle size of the external additive having a larger average primary particle size is preferably 0.05 μm or more and 0.2 μm or less. Additionally, a ratio of the average primary particle size of the external additive having a smaller average primary particle size and the average primary particle size of the external additive having a larger average primary particle size is preferably 1:5 to 1:20.

For materials constituting the external additive those customarily used in this relevant field may be used including, for example, silica, titanium oxide, silicon carbide, aluminum oxide, barium titanate and the like. Materials constituting a plurality of external additives may be the same with or different from each other. Moreover, the external additive may be subjected to hydrophobic treatment to be used.

An external additive amount of the external additive is not particularly limited, but is preferably 0.1 to 3.0 part by weight based on 100 parts by weight of the toner base particle.

(Resin-Coated Carrier)

The resin-coated carrier comprises the carrier core and the resin coating layer formed on the surface of the carrier core.

For the carrier core, those customarily used in this relevant field may be used including, for example, magnetic metal such as iron, copper, nickel and cobalt, magnetic metal oxide such as ferrite and magnetite, and the like. In a case where the carrier core is the above-described magnetic substance, a resin-coated carrier suitable for a developer that is used for a magnetic brush developing method is obtained.

The volume average particle size of the carrier core is 25 μm or more and 90 μm or less. The volume average particle size of the carrier core is 25 μm or more and 90 μm or less, so that it is possible to stable convey a toner to an electrostatic latent image that is formed an a photoreceptor, as well as form a high-definition image over a long period of time. When the volume average particle size of the carrier core is less than 25 μm, it is difficult to suppress adhesion of a carrier to a photoreceptor of a resin-coated carrier. When the volume average particle size of the carrier core exceeds 90 μm, it is impossible to form a high-definition image.

The resin coating layer coating the surface of the carrier core is formed of a silicone resin. Since the resin coating layer is formed of a silicone resin, it is possible to suppress toner spent as well as have favorable adhesiveness between the carrier core and the resin coating layer.

The silicone resin is not particularly limited and silicone resins customarily used in this relevant field may be used, however, a crosslinkable silicone resin is preferable. The crosslinkable silicone resin is, as described below, a known silicone resin in which hydroxyl groups each bonding with a Si atom or a hydroxyl group and an OX group each bonding with a Si atom are cross-linked and cured by thermal dehydration reaction, room temperature curing reaction, or the like.

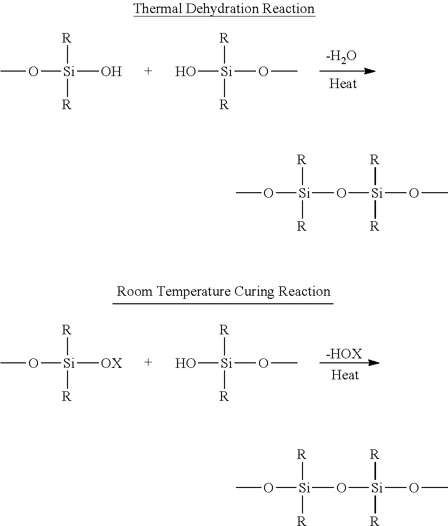

Wherein, a plurality of “P.”s represent the same or different monovalent organic groups. The OX group represents an acetoxy group, an aminoxy group, an alkoxy group, an oxime group and the like.

As the crosslinkable silicone resin, both a thermal curing-type silicone resin and a room temperature curing-type silicone resin are usable. The thermal curing-type silicone resin needs to be heated at approximately 200 to 250° C. so as to be cross-linked. The room temperature curing-type silicone resin does not need to be heated so as to be cured, however, is preferably heated at 150 to 280° C. for shortening of a curing time.

The crosslinkable silicone resin preferably has a monovalent organic group represented by R as a methyl group. Since a crosslinkable silicone resin whose R is a methyl group has a close cross-linked structure, when the crosslinkable silicone resin is used to form a resin coating layer of a carrier core, a carrier which has favorable water repellency, moisture resistance and the like is obtained. However, an overly close cross-linked structure tends to cause the resin coating layer to become fragile, therefore, it is important to select a molecular weight of the crosslinkable silicone resin.

Further, a weight ratio (Si/C) of silicon to carbon contained in the crosslinkable silicone resin is preferably 0.3 to 2.2. When the Si/C ratio is less than 0.3, the hardness of the resin coating layer is decreased and the life of the carrier and the like may be shortened. The Si/C ratio of greater than 2.2 causes a charge donating property of the resin-coated carrier with respect to the toner more likely to be subject to variations in temperature, and may therefore cause the resin coating layer to become fragile.

In the embodiment, a commercially available crosslinkable silicone resin is usable, and for example/including SR2400, SR2410, SR2411, SR2510, SR2405, 840RESIN, 804RESIN (all of which are trade names and manufactured by Dow Corning Toray Co., Ltd.), KR271, KR272, KR274, KR216, KR280, KR282, KR261, KR260, KR255, KR266, KR251, KR155, KR152, KR214, KR220, X-4340-171, KR201, KR5202, KR3093 (all of which are trade names and manufactured by Shin-Etsu Chemical Co., Ltd.) and the like.

A magnetic fine particle is contained in the resin coating layer. As the magnetic fine particle, a fine particle whose quality of materials is the same as that of the carrier core is used. The magnetic fine particle is contained in the resin coating layer, and it is thus possible to stably charge a toner over a long period of time. Such a resin-coated carrier is used to form an image, so that a high-definition image is reproduced and it is possible to stably form a high-quality image having favorable color reproducibility as well as high image density, and scarce image defects such as a fog.

Note that, in a case where a resin-coated carrier with a conductive agent that is included in a resin coating layer in place of a magnetic fine particle is used to charge a color toner with high insulation properties, in the early stages, the conductive agent allows a charge to easily flow between a toner and the resin-coated carrier so as to be able to sufficiently charge the toner. However, when the number of sheets printed is increased, that is, the toner on the surface of the resin-coated carrier is switched with another, charge is depleted, and it is impossible to sufficiently charge the toner. Such a phenomenon is, when a particle size of an external additive that is externally added to a toner is enlarged in order to improve transfer efficiency, more noticeable since the toner is prevented from coming in contact with the resin-coated carrier.

When a magnetic fine particle that is able to refresh the surface of a resin coating layer is contained in the resin coating layer, it is considered that a charge is supplied to a toner via the magnetic fine particle from inside the resin coating layer, and it is thus possible to stably charge the toner over a long period of time even in the case of a large particle size of an external additive that is externally added to the toner. Note that, refreshing the surface of the resin coating layer means that the resin coating layer on the surface of the resin-coated carrier is scraped little by little, and that a toner component and the like come to hardly adhere to the surface of the resin-coated carrier so as to stabilize charging of a toner.

Further, a magnetic fine particle is contained in a resin coating layer, so that the magnetic fine particle is prevented from being eccentrically located in a resin coating layer and between the resin-coated carriers when the resin coating layer is formed on the surface of a carrier core, and it is possible to form a uniform resin coating layer. It is not known exactly why, but it is assumed that the reason is that small magnetic fine particles are uniformly held by respective magnetic force.

Note that, in a case where a metal fine particle is used in place of the magnetic fine particle, for example, when a resin coating layer is formed in a carrier core, the metal fine particle is easily sunk in a coating resin solution described below, and the metal fine particles are eccentrically located between the resin coating layer and a resin-coated carrier, so that it is difficult to form a uniform resin coating layer. It is possible to confirm whether a uniform resin coating layer is formed by observing the resultant resin-coated carrier with an electron microscope. When the metal fine particles are eccentrically located, it is possible to confirm the exposed surface of the carrier core in places because film thickness of the resin coating layer is non-uniform. In the case of having non-uniform film thickness of the resin coating layer and non-uniform distribution of structural components of the resin coating layer, the resin-coated carriers with different resistance values come to be present, resulting in adverse effect so as to impact on a development field to distort an electric field, and the like.

A volume average particle site of a magnetic fine particle is 0.1 μm or more and 2 μm or less. The volume average particle size of a magnetic fine particle is 0.1 μm or more and 2 μm or less, so that it is possible to stably prevent a the magnetic fine particle from being eccentrically located in the resin coating layer and between resin-coated carriers when the resin coating layer is formed on the surface of a carrier core, as well as form a uniform resin coating layer since asperities are not formed on the surface of the resin coating layer with the magnetic fine particle. Accordingly, it is possible to further improve the charge donating capability to a toner of the resin-coated carrier, and to stably charge the toner over a long period of time. Moreover, it is possible to improve mechanical strength of the resin coating layer, and adhesiveness of the resin coating layer to the carrier core.

A content of the magnetic fine particle is 40 parts by weight or more and 100 parts by weight or less based on 100 parts by weight of a silicone resin solid content. When the content of the magnetic fine particle is less than 40 parts by weight, the above-described effect that is exerted by having the magnetic fine particle that is contained in a resin coating layer is unable to be sufficiently obtained. When the content of the magnetic fine particle exceeds 100 parts by weight, it is not likely to form a uniform resin coating layer as well as likely to damage a photoreceptor by the magnetic fine particle.

A conductive fine particle may be contained in a resin coating layer. As the conductive fine particle, conductive carbon black or oxide such as conductive titanic oxide or tin oxide is used. For the purpose of developing conductivity by a small additive amount, a carbon black or the like is preferably applicable, however, for a color toner, separation of the carbon black from the resin coating layer may be concerned. In this case, a conductive titanic oxide which is doped with antimony or the like is used.

A conductive fine particle is contained in a resin coating layer, so that it is possible to more stably improve the charge donating capability to a toner of a resin-coated carrier.

For further stably controlling chargeability, it is preferable to contain an organic fine particle in a resin coating layer. As the organic fine particle, a solvent of a coating resin solution described below, for example, which is not dissolved with respect to an organic solvent such as toluene, xylene and ligroin is selected. The reason is that a function of controlling charging of the organic fine particle may be lost when the organic fine particle is dissolved to cause microdispersion in the resin coating layer. Examples of such an organic fine particle include a benzoguanamine resin fine particle, a melamine resin fine particle and an organic fine particle containing a triazine ring, and among them, an organic fine particle containing a triazine ring is preferable. A volume average particle size of the organic fine particle is preferably 0.1 to 2 μm.

Additionally, for the purpose of adjustment of a toner charge amount, a silane coupling agent may be contained in a resin coating layer. With further detailed description, a silane coupling agent having a functional group with an electron-donating property is preferably used. A specific example of the silane coupling agent is an amino group-containing silane coupling agent. For the amino group-containing silane coupling agent, a known one that is represented by the following general formula (1) is usable.

(Y)nSi(R)m (1)

Wherein, the m-number of “R”s represents the same or different alkyl groups, alkoxy groups or chlorine atoms. The n-number of “Y”s represents the same or different hydrocarbon groups containing an amino group. Each of “m” and “n” represents an integer of 1 to 3, where m+n=4.]

In the above general formula (1), examples of the alkyl group represented by R include linear or branched chain alkyl groups having 1 to 4 carbon number, such as methyl group, ethyl group, propyl group, isopropyl group, butyl group and tert-butyl group. Among them, methyl group and ethyl group are preferred. Examples of the alkoxy group include linear or branched chain alkoxy groups having 1 to 4 carbon number, such as methoxy group, ethoxy group, propoxy group, isopropoxy group, butoxy group, isobutoxy group and tert-butoxy group. Among them, methoxy group and ethoxy group are preferred. Examples of the amino group-containing hydrocarbon group represented by Y include —(CH₂)ₐ—X wherein X represents amino group, aminocarbonylamino group, aminoalkyl amino group, phenyl amino group or dialkyl amino group, and a is an integer of from 1 to 4, and -Ph-X wherein X is the same as defined above, and -Ph- represents phenylene group.

Specific examples of the amino group-containing silane coupling agent include the following compounds:

H₂N(H₂C)₃Si(OCH₃)₃,

H₂N(H₂C)₃Si (OC₂H₅)₃,

H₂N(H₂C)₃Si(CH₃)(OCH₃)₂,

H₂N (H₂C)₂HN(H₂C)Si (CH₃)(OCH₃)₂,

H₂NOCHN(H₂C)₃Si(OC₂H₅)₃,

H₂N(H₂C)₂HN(H₂C)₃Si (OCH₃)₃,

H₂N-Ph-Si(OCH₃)₃ wherein -Ph- represents p-phenylene group,

Ph-HN(H₂C)₃Si(OCH₃)₃ wherein Ph- represents phenyl group, and

H₉C₄)₂N(H₂C)₃Si (OCH₃)₃.

The amino group-containing silane coupling agents may be used each alone, or two or more of them may be used in combination. The amount of the amino group-containing silane coupling agent used is appropriately selected from a range that imparts sufficient charge to the toner and does not remarkably decrease mechanical strength and the like of the resin coating layer. The amount is preferably 10 parts by weight or less, and further preferably from 0.01 to 10 parts by weight, based on 100 parts by weight of the silicone resin

In the case that the resin coating layer contains a silicone resin, the resin coating layer can contain other resin in a range of not impairing preferable characteristics of the resin coating layer formed by a silicone resin (particularly, crosslinkable silicone resin), together with the silicone resin. Examples of the other resin include epoxy resin, urethane resin, phenol resin, acrylic resin, styrene resin, polyamide, polyester, acetal resin, polycarbonate, vinyl chloride resin, vinyl acetate resin, cellulose resin, polyolefin, their copolymer resins and their compounded resins. The resin coating layer may contain a bifunctional silicon oil in order to further improve moisture resistance and releasability of the resin coating layer formed by a silicone resin (particularly, crosslinkable silicone resin)

A resin-coated carrier is obtained by applying a coating resin solution in which construction materials of the above-described resin coating layer are dissolved or dispersed in a solvent to the surface of a carrier core, and thereafter volatizing and removing the above-described solvent to form a coated layer, followed by heat curing or simple curing of the coated layer at the time of drying or after drying.

The solvent is not particularly limited in so far as it is capable of dissolving a silicone resin, and examples thereof include aromatic hydrocarbon such as toluene and xylene, ketone such as acetone and methyl ethyl ketone, ether such as tetrahydrofuran and dioxane, higher alcohol and a mixed solvent of two or more of these substances. Using a coating resin solution facilitates formation of a resin coating layer on the surface of a carrier core.

The methods of applying the coating resin solution to the surface of the carrier core include, for example, a dipping method in which the carrier core is impregnated in the coating resin solution, a spray method in which the carrier core is sprayed with the coating resin solution, a fluidized-bed method in which the carrier core which is in suspension due to a fluidized air stream is sprayed with the coating resin solution, and the like. Among them, the dipping method is preferable since it facilitates formation of a resin coating layer.

Drying of the coated layer may use a dry accelerator. The dry accelerator can use the conventional dry accelerators, and examples thereof include metallic soaps such as lead, iron, cobalt, manganese and zinc salts of naphthylic acid and octylic acid and organic amines such as ethanolamine. The dry accelerators may be used each alone, or two or more of them may be used in combination.

Curing of the coated layer is conducted while selecting a heating temperature according to the kind of the coating resin. For example, the curing is preferably conducted by heating at about 150 to 280° C. In the case that a silicone resin is a room temperature curing type silicone resin, heating is not necessary. However, the coated layer may be heated at about 150 to 280° C. for the purpose of improving mechanical strength of a resin coating layer formed and shortening a curing time.

Note that, concentration for all solid contents of the coating resin solution is not particularly limited, and adjustment may be made, in consideration of a working property of application to the carrier core, such that film thickness of the resin coating layer after curing is generally 5 μm or less, preferably approximately 0.1 to 3 μm.

Although the resin-coated carrier that is obtained in this manner has preferably high electrical resistance and a spherical shape, even having conductivity or a non-spherical shape does not cause loss of the effect of the technology.

The two-component developer according to the embodiment can be manufactured by mixing the toner and the above-mentioned resin-coated carrier. A mixing ratio of the toner and the resin-coated carrier is not particularly limited and in consideration of the use thereof in a high-speed image forming apparatus (which forms A4-sized images on 40 sheets or more per minute), t is preferred that a ratio of a total projected area of the toner (a sum of projected areas of all the toner particles) relative to a total surface area of the resin-coated carrier (a sum of surface areas of all the resin-coated carrier particles), that is, ((the total projected area of the toner/the total surface area of the resin-coated carrier)×100), is 30% to 70% in a state where a ratio represented by (an average particle size of the resin-coated carrier/an average particle size of the toner) is 5 or more. This allows the charging property of the toner to be stably maintained in a sufficiently favorable state, resulting in a favorable two-component developer which can stably form high-quality images for a long period of time even in a high-speed image forming apparatus.

For example, assuming that: the volume average particle size of the toner is set at 6.5 μm; the volume average particle size of the resin-coated carrier is set at 90 μm; and the ratio of the total projected area of the toner relative to the total surface area of the resin-coated carrier is set in a range of 30% to 70%, the two-component developer will contain around 2.2 to 5.3 parts by weight of the toner based on 100 parts by weight of the resin-coated carrier. The high-speed development using the two-component developer as just described leads to the largest amount of toner consumption and the largest amount of toner supply that is supplied to a developer tank of a developing device according to the consumption of toner and toner. Nevertheless, the balance of supply and demand will not be lost. And when the amount of the resin-coated carrier contained in the two-component developer exceeds a value around 2.2 to 5.3 parts by weight, the amount of charges tends to be smaller, thus failing to obtain the desired developing property, and moreover the amount of toner consumption is larger than the amount of toner supply, thus failing to impart sufficient charges to the toner, which causes the deterioration of image quality. Furthermore, when the amount of the resin-coated carrier contained in the developer is small, the amount of charges tends to be larger and thus, the toner is less easily separated from the resin-coated carrier through the electric field, thereby causing the deterioration of image quality.

Note that, the total projected area of the toner was determined as follows. Assuming that specific gravity of the toner was 1.0, the total projected area of the toner was determined based on the volume average particle size obtained by a Coulter counter: COULTER COUNTER MULTISIZER II (trade name, manufactured by Beckman Coulter, Inc.) That is, the number of the toners relative to the weight of the toners to be mixed was counted, and the number of the toners was multiplied by the area of the toners (which was obtained based on the assumption that the area is a circle) to thus obtain a total projected area of the toner. In a similar fashion, a total surface area of the resin-coated carrier was determined from the weight of the resin-coated carriers to be mixed based on the particle size which had been obtained by Microtrac (trade name: Microtrac MT3000, manufactured by NIKKISO CO., LTD.) In this case, specific gravity of the resin-coated carrier was defined as 4.7. Using the values obtained as above, the mixing ratio of the toner and the carrier was determined by (the total projected area of the toner/the total surface area of the resin-coated carrier)×100.

2. Image Forming Method

For a multicolor image forming method according to one embodiment, the two-component developer according to the embodiment is used.

The multicolor image forming method is performed, for example, with use of an electrophotographic image forming apparatus comprising an image bearing member having a photosensitive layer on a surface of which an electrostatic charge image may be formed; a charging section for charging the surface of the image bearing member to predetermined potential; an exposure section for irradiating the image bearing member whose surface is in a charging state with signal light according to image information to form an electrostatic charge image (electrostatic latent image) on the surface of the image bearing member; a developing section including a developer conveyance bearing member for supplying a developer to the electrostatic charge image and developing the electrostatic latent image to form a toner image; a transfer section for transferring the toner image on the surface of the image bearing member to a recording medium; a fixing section for fixing the toner image on the surface of the recording medium to the recording medium; and a cleaning section for removing a toner, paper dust and the like remaining on the surface of the image bearing member after transferring of the toner image to the recording medium.

In development of the electrostatic charge image, an electrostatic latent image formed on an image bearing member by the charging section and the exposure section; the two-component developer of the embodiment that is carried by the developer conveyance bearing member is conveyed to a developing area that is formed in an area where the developer conveyance bearing member is close to the image bearing member; a developing step is repeatedly executed such that the electrostatic charge image on the image bearing member is visualized by a reversal development method under an oscillating electric field formed by applying alternating bias voltage to the developer conveyance bearing member; and a plurality of toner images with different colors are overlaid onto the image bearing member to form a multicolor toner image.

According to the multicolor image forming method of the embodiment, it is possible to stably form a high-definition multicolor image with high image density having excellent image reproducibility including color reproducibility in the long term.

### EXAMPLES

Examples and comparative examples will be described below.

(Volume Average Particle Sizes of Carrier Core, Magnetic Fine Particle, Nonmagnetic Fine Particle and Organic Fine Particle)

Approximately 10 to 15 mg of a measurement sample was added to 10 mL of a solution having 5% EMULGEN 109P (manufactured by Kao Corporation, polyoxyethylene laurylether HLB 13.6) which was dispersed by an ultrasonic dispersing device for 1 minute. After approximately 1 mL of the dispersed mixture was added to a predetermined point of a Microtrac MT3000 (manufactured by Nikkiso Co., Ltd.), followed by stirring for 1 minute, and it was confirmed that the scattered light intensity became stable, thereafter measurement was made.

(Average Primary Particle Size of External Additive)

Fixing processing was performed for dispersing an external additive in a resin to be fixed, followed by observation by the TEM, then any 30 pieces of which were extracted, and particle sizes of those external additives were averaged to obtain an average primary particle size of the external additive.

(Volume Average Particle Size of Toner Base Particle)

To 50 ml of an electrolytic solution (trade name: ISOTON-II, manufactured by Beckman Coulter, Inc.), 20 ml of the sample and 1 ml of sodium alkylether sulfate were added, followed by dispersion processing for 3 minutes at 20 kHz ultrasonic frequencies by an ultrasonic dispersing device (trade name: UH-50, manufactured by SMT Co., Ltd.), and a measurement sample was prepared. For the measurement sample, measurement was made with use of a particle size distribution measuring device (trade name: Microtrac MT3000, manufactured by Nikkiso Co., Ltd.) under conditions where an aperture diameter was 100 μm and the number of measurement particles was 50000 counts, and a volume average particle size (μm) of the sample was obtained from volume particle size distribution of the sample.

(Melting Point of Wax)

Using a differential scanning calorimeter (trade name: Diamond DSC, manufactured by PerkinElmer Japan Co., Ltd.), an operation of heating 0.01 g of the sample from the temperature of 20° C. to 200° C. at a temperature rise rate of 10° C. per minute and then immediately cooling from 200° C. to 20° C. was repeated twice, thereby measuring a DSC curve. An endothermic peak temperature corresponding to melting of the DSC curve measured in the second operation was regarded as a melting point (° C.).

[Manufacturing of Resin-Coated Carriers 1 to 8 and 10 to 12]

A mixture containing a silicone resin (a solid content of the silicone resin is shown in parentheses), magnetic fine particles, conductive particles, organic fine particle, a coupling agent and toluene, each in such a used amount (parts by weight) that is shown in Table 1 below, were stirred by a three-one motor for 5 minutes to prepare a coating resin solution. Note that, the conductive fine particles were used in the form of being in advance dispersed in a toluene solvent by means of a dispersing agent. The coating resin solution was mixed with a ferrite core (carrier core) having the volume average particle size (μm) shown in Table 1 below that was added in the content shown in Table 1 below, and inputted into a stirring machine to be further mixed. From the resultant mixture, toluene was removed by reducing pressure and heating, and a coated layer was formed on the surface of the ferrite core. The mixture was heated at 200° C. for 1 hour so that the coated layer was cured, whereby a resin coating layer was formed, followed by sifting with a 100-mesh sieve, and resin-coated carriers 1 to 8 and 10 to 12 were manufactured.

Specifically, as a silicone resin, a conductive particle and a metal magnetic fine particle, the following ones were used.

Silicone resin (a) Trade name: KR 350, manufactured by Shin-Etsu Chemical Co., Ltd., solution having 20% silicone resin content

Conductive particle (b) Trade name: VULCANXC72, manufactured by Cabot Corporation, carbon black-toluene dispersing conductive solution having 15% solid concentration

Organic fine particle (c) Trade name: EPOSTAR, manufactured by NIPPON SHOKUBAI Co., Ltd., organic crosslinkable fine particle comprising a resin having a triazine ring, volume average particle size: 0.4 μm

Magnetic fine particle (d) Trade name: BL-400, manufactured by Titan Kogyo, Ltd., barium ferrite fine particle, volume average particle size: 0.2 μm

Magnetic fine particle (e) Trade name: BL-10, manufactured by Titan Kogyo, Ltd., magnetite fine particle, volume average particle size: 1.3 μm

Magnetic fine particle (f) Trade name: RB-BL, manufactured by Titan Kogyo, Ltd., magnetite fine particle, volume average particle size: 2.0 μm

Magnetic fine particle (g) Trade name: RB-SP, manufactured by Titan Kogyo, Ltd., magnetite fine particle, volume average particle size: 3.0 μm

Coupling agent (h) Trade name: SH6020, manufactured by Dow Corning Toray Co., Ltd., 100% solution

[Manufacturing of Resin-Coated Carrier 9]

With use of 16 parts by weight of a nonmagnetic fine particle (trade name: BAIKALOX 0.3CR, manufactured by Baikowski, alumina fine particle, particle size: 0.3 μm) in place of a magnetic fine particle, and with use of coating resin solution raw materials shown in Table 1 below in addition to the nonmagnetic fine particle, a resin-coated carrier 9 was obtained by the same method as the method of manufacturing the resin-coated carriers 1 to 8 and 10 to 12.

TABLE 1

| | | | Coating Resin | | | | | | | | | | | |
|---|---|---|---|---|---|---|---|---|---|---|---|---|---|---|
| | | | | | Magnetic fine | | Conductive fine | | Organic fine | | | | | |
| | Carrier core | | Silicone resin | | particle | | particle | | particle | | Coupling agent | | Solvent | |
| | Volume | Additive | | Additive | | Additive | | Additive | | Additive | | Additive | | Additive |
| Resin- | average | amount | | amount | | amount | | amount | | amount | | amount | | amount |
| coated | particle | (parts by | | (parts by | | (parts by | | (parts by | | (parts by | | (parts by | | (parts by |
| carrier | size (μm) | weight) | Type | weight) | Type | weight) | Type | weight) | Type | weight) | Type | weight) | Type | weight) |
| 1 | 35 | 1000 | a | 150(30) | d | 12 | — | — | — | — | h | 3 | Toluene | 200 |
| 2 | 45 | 1000 | a | 100(20) | e | 20 | b | 5 | c | 6 | h | 4 | Toluene | 150 |
| 3 | 80 | 1000 | a | 100(20) | f | 16 | b | 5 | c | 5 | h | 2 | Toluene | 100 |
| 4 | 25 | 1000 | a | 200(40) | d | 24 | b | 5 | c | 6 | h | 3 | Toluene | 200 |
| 5 | 90 | 1000 | a | 100(20) | e | 16 | b | 5 | c | 4 | h | 4 | Toluene | 150 |
| 6 | 40 | 1000 | a | 140(70) | d | 63 | b | 5 | — | — | h | 4 | Toluene | 200 |
| 7 | 45 | 1000 | a | 100(20) | — | — | b | 4 | c | 6 | h | 4 | Toluene | 150 |
| 8 | 23 | 1000 | a | 100(20) | g | 16 | — | — | — | — | h | 4 | Toluene | 100 |
| 9 | 100 | 1000 | a | 100(20) | — | — | b | 5 | c | 6 | h | 4 | Toluene | 100 |
| 10 | 30 | 1000 | a | 100(20) | f | 22 | b | 4 | c | 4 | h | 3 | Toluene | 100 |
| 11 | 30 | 1000 | a | 100(20) | g | 20 | b | 5 | c | 5 | h | 4 | Toluene | 100 |
| 12 | 45 | 1000 | a | 100(20) | — | — | b | 6 | c | 5 | h | 4 | Toluene | 100 |

[Toner (1)]

Polyester resin (acid value: 21 mg KOH/g)

Aromatic alcohol component: PO-BPA and EP-BPA

Acid component: fumaric acid and mellitic anhydride)
87.5% by weight

C.I. Pigment Blue 15:1 (colorant) 5% by weight

Non-polar paraffin wax (Melting point: 78° C., weight average molecular weight Mw: 8.32×10²)
6.0% by weight

Charge control agent: BONTRON E-84 (trade name, manufactured by Orient Chemical Industries Co., Ltd.)
1.5% by weight

The above-described constituent materials were premixed by HENSCHEL MIXER, and thereafter the resultant was melt-kneaded by a biaxial extruding kneader. The kneaded product was coarsely pulverized by a cutter mill, thereafter was finely pulverized by a jet mill, and classified by a pneumatic classifier, and then a toner base particle having a volume average particle size of 6.5 μm was prepared. Subsequently, to 97.8% by weight of the classified toner base particle, 1.2% by weight of silica having an average primary particle size of 100 nm that was subjected to hydrophobic treatment with i-butyltrimethoxysilane, and 1.0% by weight of a silica fine particle having an average primary particle size of 12 nm that was subjected to hydrophobic treatment with HMDS were added to be mixed by HENSCHEL MIXER, followed by an external addition process, and a toner 1 (cyan toner) was obtained.

[Manufacturing of Toner 2]

A toner 2 was obtained in the same manner as manufacturing of the toner 1 except that C.I. Pigment Blue 15:1 was changed to carbon black.

[Manufacturing of Toner 3]

A toner 3 was obtained in the same manner as manufacturing of the toner 1 except that a charge control agent whose trade name is E-81 was changed to a charge control agent whose trade name is LR-147 (manufactured by Japan Carlit Co., Ltd.).

[Manufacturing of Toner 4]

A toner 4 was obtained in the same manner as manufacturing of the toner 1 except that the silica having an average primary particle size of 100 nm that was subjected to hydrophobic treatment was not used.

### Examples 1 to 13, Comparative Examples 1 to 9

As shown in Table 2 below, a toner was combined with a resin-coated carrier so that two-component developers of Examples 1 to 13 and Comparative Examples 1 to 9 were obtained.

The following evaluation was performed with use of the two-component developers.

[Chargeability]

i. Initial Chargeability

The above-described two-component developers was set in a copier (MX-6000N, manufactured by Sharp Corporation) including a commercially available two-component developing device, and after idling for 3 minutes at normal temperature and normal humidity, the two-component developer was extracted, then the charge amount was measured by a suction-type charge amount measuring device (TREK Inc.: 210H-2A Q/M Meter). Judgment was made such that a charge amount of −25 μC/g or more was rated as favorable (Good), a charge amount of −20 μC/g or more and −25 μC/g or less was rated as usable (Not bad), and a charge amount of less than −20 μC/g was rated as no good (Poor).

ii. Charging Rise Characteristics

After a 5-ml glass bottle containing 0.95 g of a resin-coated carrier and 0.05 g of a toner described above was stirred for 1 minute by a 32-rpm rotary incubator, a two-component developer was extracted, and a charge amount was measured by a suction-type charge amount measuring device. Further, the resin-coated carrier and the toner were stirred in the same manner for 3 minutes of the changed stirring time, and thereafter a charge amount was measured in the same manner. Judgment was made such that, as the difference between a charge amount after 1 minute and a charge amount after 3 minutes, an absolute value of 5 μC/g was rated as favorable (Good), an absolute value of exceeding 5 μC/g and 7 μC/g or less was rated as usable (Not bad), and an absolute value of exceeding 7 μC/g was rated as no good (Poor).

iii. Charging Life Property

The above-described two-component developer was set in a copier (MX-6000N, manufactured by Sharp Corporation) including a commercially available two-component developing device, and after 50,000 prints of a solid image were produced at normal temperature and normal humidity, image density in an image section, whiteness in a non-image section, and a charge amount of the two-component developer were measured. The image density was measured by an X-Rite 938 spectrocolorimetric densitometer, and judgment was made such that image density of 1.4 or more was rated as favorable (Good), and image density of less than 1.4 was rated as no good (Poor). Regarding the whiteness, the tristimulus values X, Y and Z were obtained with use of a SZ90 spectral color difference meter manufactured by Nippon Denshoku Kogyo Co., Ltd, and judgment was made such that a Z value of 0.5 or less was rated as favorable (Good), a Z value of exceeding 0.5 and 0.7 or less was rated as usable (Not bad), and a Z value of exceeding 0.7 was rated as no good (Boor). A charge amount of the two-component developer was measured by a suction-type charge amount measuring device, and judgment was made such that, as the difference from an initial charge amount in the initial chargeability, an absolute value of 5 μC/g or less was rated as favorable (Good), an absolute value of exceeding 5 μC/g and 7 μC/g or less was rated as usable (Not bad), and an absolute value of exceeding 7 μC/g was rated as no good (Poor).

iv. Transfer Efficiency

Transfer efficiency T (%) was calculated from the following formula (2). Judgment was made such that transfer efficiency T of 90% or more was rated as favorable (Good), and transfer efficiency T of less than 90% was rated as no good (Poor).

T(%)=[Mp/(Md+Mp)]×100 (2)

Wherein, Mp represents the weight of a toner on a sheet onto which a predetermined chart was printed, and Mp represents the weight of a toner remaining on the surface of an image bearing member (electrophotographic photoreceptor) when the predetermined chart was printed. Here, the predetermined chart is comprised of 4 cm×4 cm patches which were positioned at four corners (with a margin of 1.5 cm at each side of the sheet) of an A4 sheet, and at the central part thereof.

v. Coated State of Resin Coating Layer

First, a resin-coated carrier right after manufacturing shown in Table 1 was observed by an electronic microscope, and a state of a resin coating layer was confirmed. As a result, in both the resin-coated carriers 8 and 10, an exposed part of a carrier core was observed, thus judging that the coated state was no good (Poor).

Thereafter, the resin-coated carrier was taken out of the two-component developer after the charging life property was tested, and observed by an electronic microscope. Judgment was made such that a case of a less change of the resin coating layer compared to that at the time of manufacturing of the resin-coated carrier was rated as favorable (Good), and a case where a resin coating layer was obviously worn away so that the exposed parts of the carrier core were increased was rated as no good (Poor).

[Comprehensive Evaluation]

The above-described evaluation results were used to perform comprehensive evaluation. A case where all of the above-described evaluation results were rated as “Good” was rated as “Excellent”, a case where there is no “Poor” but at least one “Not bad” in the above-described evaluations was rated as “Good”, and a case where there is at least one “Poor” in the above-described evaluation results was rated as “Poor”.

Comprehensive evaluation standards were as follows.

Types of toners and resin-coated carriers that are combined with one another, as well as evaluation results and comprehensive evaluation results are shown in Table 2.

TABLE 2

| | | | | Chargeability | | | | | |
|---|---|---|---|---|---|---|---|---|---|
| | | | | | | Charging rise characteristics | | | |
| | | Resin- | | Intial chargeability | | | | Difference | |
| | | coated | Mixing | Charge | | After 1 | After 3 | of charge | |
| | Toner | carrier | ratio | amount | Evaluation | minute | minutes | amounts | Evaluation |
| Ex. 1 | 1 | 1 | 60 | 34 | Good | 30 | 34 | 4 | Good |
| Ex. 2 | 1 | 2 | 65 | 33 | Good | 30 | 35 | 5 | Good |
| Ex. 3 | 1 | 3 | 70 | 27 | Good | 25 | 30 | 5 | Good |
| Ex. 4 | 1 | 4 | 50 | 33 | Good | 30 | 35 | 5 | Good |
| Ex. 5 | 2 | 5 | 45 | 26 | Good | 25 | 30 | 5 | Good |
| Ex. 6 | 2 | 1 | 40 | 31 | Good | 32 | 35 | 3 | Good |
| Ex. 7 | 2 | 2 | 35 | 30 | Good | 28 | 32 | 4 | Good |
| Ex. 8 | 2 | 3 | 30 | 25 | Good | 23 | 26 | 3 | Good |
| Ex. 9 | 3 | 4 | 45 | 33 | Good | 30 | 35 | 5 | Good |
| Ex. 10 | 3 | 5 | 50 | 25 | Good | 24 | 29 | 5 | Good |
| Ex. 11 | 3 | 1 | 50 | 31 | Good | 33 | 35 | 6 | Good |
| Ex. 12 | 3 | 2 | 50 | 29 | Good | 32 | 34 | 2 | Good |
| Ex. 13 | 3 | 6 | 60 | 30 | Good | 28 | 32 | 4 | Good |
| Comp. Ex. 1 | 1 | 7 | 50 | 35 | Good | 33 | 36 | 3 | Good |
| Comp. Ex. 2 | 1 | 8 | 50 | 33 | Good | 26 | 29 | 3 | Good |
| Comp. Ex. 3 | 2 | 9 | 50 | 28 | Good | 28 | 30 | 2 | Good |
| Comp. Ex. 4 | 2 | 10 | 50 | 26 | Good | 19 | 21 | 2 | Good |
| Comp. Ex. 5 | 4 | 1 | 60 | 35 | Good | 32 | 35 | 3 | Good |
| Comp. Ex. 6 | 2 | 11 | 50 | 32 | Good | 31 | 33 | 2 | Good |
| Comp. Ex. 7 | 2 | 12 | 50 | 33 | Good | 30 | 32 | 2 | Good |
| Comp. Ex. 8 | 1 | 1 | 75 | 22 | Not bad | 30 | 34 | 4 | Good |
| Comp. Ex. 9 | 1 | 3 | 25 | 33 | Good | 25 | 30 | 5 | Good |

| | Chargeability | | | | | | |
|---|---|---|---|---|---|---|---|
| | Charging life property | | | | | | |
| | | | | | | Difference | |
| | Image | | | | Charge | of charge | |
| | density | Evaluation | Z value | Evaluation | amount | amounts | Evaluation |
| Ex. 1 | 1.4 | Good | 0.5 | Good | 29 | 5 | Good |
| Ex. 2 | 1.5 | Good | 0.3 | Good | 29 | 4 | Good |
| Ex. 3 | 1.6 | Good | 0.5 | Good | 28 | 1 | Good |
| Ex. 4 | 1.4 | Good | 0.5 | Good | 28 | 5 | Good |
| Ex. 5 | 1.4 | Good | 0.4 | Good | 21 | 5 | Good |
| Ex. 6 | 1.5 | Good | 0.5 | Good | 26 | 5 | Good |
| Ex. 7 | 1.5 | Good | 0.5 | Good | 26 | 4 | Good |
| Ex. 8 | 1.6 | Good | 0.5 | Good | 20 | 4 | Good |
| Ex. 9 | 1.4 | Good | 0.5 | Good | 28 | 5 | Good |
| Ex. 10 | 1.4 | Good | 0.4 | Good | 28 | 4 | Good |
| Ex. 11 | 1.4 | Good | 0.3 | Good | 29 | 2 | Good |
| Ex. 12 | 1.5 | Good | 0.5 | Good | 26 | 3 | Good |
| Ex. 13 | 1.4 | Good | 0.5 | Good | 29 | 1 | Good |
| Comp. Ex. 1 | 1.4 | Good | 0.5 | Good | 13 | 22 | Poor |
| Comp. Ex. 2 | 1.5 | Good | 0.5 | Good | 10 | 23 | Poor |
| Comp. Ex. 3 | 1.5 | Good | 0.8 | Poor | 14 | 14 | Poor |
| Comp. Ex. 4 | 1.6 | Good | 0.7 | Not bad | 13 | 13 | Poor |
| Comp. Ex. 5 | 1.4 | Good | 0.5 | Good | 29 | 6 | Not bad |
| Comp. Ex. 6 | 1.4 | Good | 0.7 | Not bad | 25 | 7 | Poor |
| Comp. Ex. 7 | 1.4 | Good | 0.5 | Good | 25 | 8 | Poor |
| Comp. Ex. 8 | 1.6 | Good | 0.9 | Poor | 15 | 7 | Poor |
| Comp. Ex. 9 | 1.4 | Good | 0.5 | Good | 40 | 7 | Poor |

| | Transfer efficiency | | Coated state | |
|---|---|---|---|---|
| | Transfer efficiency | Evaluation | Evaluation | Comprehensive evaluation |
| Ex. 1 | 91 | Good | Good | Excellent |
| Ex. 2 | 92 | Good | Good | Excellent |
| Ex. 3 | 91 | Good | Good | Excellent |
| Ex. 4 | 90 | Good | Good | Excellent |
| Ex. 5 | 90 | Good | Good | Excellent |
| Ex. 6 | 90 | Good | Good | Excellent |
| Ex. 7 | 91 | Good | Good | Excellent |
| Ex. 8 | 92 | Good | Good | Excellent |
| Ex. 9 | 90 | Good | Good | Excellent |
| Ex. 10 | 93 | Good | Good | Excellent |
| Ex. 11 | 92 | Good | Good | Excellent |
| Ex. 12 | 91 | Good | Good | Excellent |
| Ex. 13 | 90 | Good | Good | Excellent |
| Comp. Ex. 1 | 91 | Good | Good | Poor |
| Comp. Ex. 2 | 90 | Good | Poor | Poor |
| Comp. Ex. 3 | 92 | Good | Poor | Poor |
| Comp. Ex. 4 | 92 | Good | Poor | Poor |
| Comp. Ex. 5 | 85 | Poor | Good | Poor |
| Comp. Ex. 6 | 90 | Good | Poor | Poor |
| Comp. Ex. 7 | 90 | Good | Good | Poor |
| Comp. Ex. 8 | 90 | Good | Good | Poor |
| Comp. Ex. 9 | 90 | Good | Good | Poor |

From Table 2, it is found that both a color toner and a black toner have chargeability, transfer efficiency and a coated state of a resin coating layer that are favorable according to Examples 1 to 13.

In Comparative examples 1 and 7, a magnetic fine particle was not contained in a resin coating layer, so that the charging life property was significantly lowered.

In Comparative Examples 2 and 3, a particle size of a carrier core was too small or too large to obtain favorable results.

In Comparative Example 4, the content of magnetic fine particles with respect to the silicone resin was too large so as to have a poor coated state, and the charging life property was significantly lowered.

In Comparative Example 5, an external additive having an average primary particle size of 100 nm or more was not added to a toner, so that transfer efficiency was lowered.

In Comparative Example 6, a particle size of a magnetic fine particle was too large to have a poor coated state, so that the charging life property was significantly lowered.

In Comparative Examples 0 and 9, a mixing ratio of a resin-coated carrier and a toner was too small or too large, so that the charging life property was significantly lowered.

The technology is able to be performed in various other farms without departing from the spirit or essential characteristics thereof. Therefore, the above-described embodiments are only illustrated in all respects, and the scope of the technology is indicated by the appended claims rather than by the foregoing description. Additionally, all modifications or changes that come within the claims are intended to be embraced therein.

What is claimed is:

1. A two-component developer comprising:
a toner to which a plurality of types of external additives each of which has a different average primary particle size are externally added, at least one of the plurality of types of external additives having an average primary particle size of 0.1 μm or more; and
a resin-coated carrier comprising a carrier core formed of ferrite having a volume average particle size of 25 μm or more and 90 μm or less, and a resin coating layer that is formed on a surface of the carrier core and contains magnetic fine particles having a volume average particle size of 0.1 μm or more and 2 μm or less and a silicone resin, in which 40 parts by weight or more and 100 parts by weight or less of the magnetic fine particles based on 100 parts by weight of the silicone resin are contained,
a mixing ratio of the resin-coated carrier and the toner indicated by a ratio of a total projected area of the toner relative to a total surface area of the resin-coated carrier being 30% or more and 70% or less.

2. The two-component developer of claim 1, wherein the resin coating layer further contains organic fine particles comprising an organic substance.

3. The two-component developer of claim 2, wherein the organic fine particles are formed of a resin that is selected from a benzoguanamine resin, a melamine resin and a resin having a triazine ring.

4. An image forming method comprising the steps of:
forming a latent image on an image bearing member; and
developing the latent image formed on the image bearing member to form a toner image with use of the two-component developer of claim 1.
